(19) United States
(12) Patent Application Publication
(10) Pub. No.: US 2017/0272402 A1
(43) Pub. Date: Sep. 21, 2017

(54) METHOD AND ELECTRONIC DEVICE FOR SEARCHING FOR SPECIAL CONTACTS

(71) Applicant: Dongguan Yulong Telecommunication Tech Co., Ltd., Dongguan (CN)

(72) Inventor: Haifeng DENG, Guangdong (CN)

(73) Assignee: Dongguan Yulong Telecommunication Tech Co., Ltd., Dongguan (CN)

(21) Appl. No.: 15/613,402

(22) Filed: Jun. 5, 2017

Related U.S. Application Data
(63) Continuation of application No. PCT/CN2014/095995, filed on Dec. 31, 2014.

(30) Foreign Application Priority Data
Dec. 4, 2014 (CN) 201410736310.X

(51) Int. Cl. H04L 29/12; H04M 1/2745; G06F 17/30; G06F 3/023; G06Q 10/10

(52) U.S. Cl. CPC H04L 61/1594; G06F 3/0237; G06Q 10/107; G06F 17/30; H04M 1/274508; G06F 17/30979

(57) ABSTRACT

The present invention provides a method and electronic device for searching for special contacts. The method for searching for special contacts comprises: receiving a search string input by a user; parsing the search string to obtain a feature code corresponding to a capability type of target contacts and a keyword used for searching to obtain the target contacts; and according to the feature code and the keyword, searching, in a contact database, for contacts having contact information matching the keyword and having the capability type corresponding to the feature code, and using the found contacts as the target contacts. By means of the technical solution of the present invention, exact search for target contacts having a specified capability type is realized, and information of all the target contacts having the specified capability type can be found, thereby meeting a user demand of searching for special contacts, improving the accuracy of contact search, and contributing to improvement of the operating experience of the user.

### CROSS REFERENCE

The present application is a continuation of International Application No. PCT/CN2014/095995, filed on Dec. 31, 2014, the entire content of which is incorporated herein by reference. The International Application No. PCT/CN2014/095995 claims priority to Chinese Application No. 201410736310.X filed on Dec. 4, 2014.

### TECHNICAL FIELD

The present invention relates to the field of a terminal technology, and particularly to a method for searching for special contacts and an electronic device for searching for special contacts.

### BACKGROUND ART

As a set of abundant communication services integrating voice, message, video and content sharing based on an enhanced phone book, RCS (Rich Communication Suite) provides users with abundant communications services through effective binding and integrating with the existing standardized service, so as to help the operators to occupy an active position in the wireless community market, and improve the user viscosity whilst improving the ARPU (Average Revenue Per User). RCS contacts are stored in an enhanced phone book of the RCS. Each of RCS contacts has a corresponding capability, such as a voice call capability, a video call capability, a live chat capability, a file transfer capability, and so on.

At present, most of the methods for searching for contacts proposed in relevant technologies are based on keyword search, i.e., directly exactly or fuzzily match a search keyword in a contact database, and display the search result to a user.

However, since the RCS contacts have more capability properties, it is impossible to meet a user demand of searching for RCS contacts simply relying on the above search methods proposed in relevant technologies, specifically for the following reasons:
1) failing to find contacts only belonging to RCS during search;
2) failing to only search for RCS contacts having a certain capability property during search;
3) when a user searches for a RCS contact to originate a chat, the search result fails to reflect whether the counterpart has a chatting capability, but the user will still be able to find the counterpart, thereby wasting the user time; and
4) failing to distinguish between types during search, so that the search result is not exact enough to meet the real needs of users.

Therefore, how to exactly find information of target contacts having a specified capability type to meet a user demand of searching for RCS contacts and improve the accuracy of contact search becomes a technical problem in urgent need of solution.

### SUMMARY OF THE INVENTION

Based on at least one of the above technical problems, the present invention proposes a novel solution for searching for special contacts, realizes exact search for target contacts having a specified capability type, and can also find information of all the target contacts having the specified capability type, thereby meeting a user demand of searching for special contacts (such as RCS contacts), improving the accuracy of contact search, and contributing to improvement of the operating experience of the user.

In view of this, the present invention proposes a method for searching for special contacts, comprising: receiving a search string input by a user; parsing the search string to obtain a feature code corresponding to a capability type of target contacts and a keyword used for searching to obtain the target contacts; and according to the feature code and the keyword, searching, in a contact database, for contacts having contact information matching the keyword and having the capability type corresponding to the feature code, and using the found contacts as the target contacts.

In the technical solution, through parsing a search string input by a user to obtain a feature code corresponding to a capability type of target contacts and a keyword used for searching to obtain the target contacts, a user can realize exact search for target contacts having a specified capability type when searching for target contacts in a contact database by inputting a search string comprising a feature code corresponding to a capability type of target contacts, and can also find information of all the target contacts having the specified capability type, thereby meeting a user demand of searching for special contacts (such as RCS contacts), avoiding the problem that it is impossible for a user to only search for special contacts because search can only be carried out by keywords in relevant technologies, improving the accuracy of contact search, and contributing to improvement of the operating experience of the user. If the keyword obtained through parsing the search string is empty, it indicates that it is necessary to search for all the contacts having the capability type corresponding to the parsed feature code; or if the feature code obtained through parsing the search string is empty, it indicates that contacts are searched for only based on the user-entered search string as the keyword.

Preferably, the above step of searching, in a contact database, for contacts having contact information matching a keyword and having a capability type corresponding to a feature code in accordance with the feature code and the keyword, may be firstly searching according to the feature code and then searching according to the keyword, namely, searching for contacts having the capability type corresponding to the feature code in a contact database according to the feature code, and searching for information of the target contacts from the contacts having the capability type found through the keyword; and may also be firstly searching based on the keyword and then searching based on the feature code, or searching based on both the keyword and the feature code.

Preferably, before the step of searching, in a contact database, for contacts having contact information matching the keyword and having the capability type corresponding to the feature code, the above technical solution further comprises: identifying capability types of all the contacts in the contact database; and correspondingly storing a capability type of each contact among all the contacts, as well as the feature code corresponding to the capability type.

In this technical solution, through identifying the capability types of all the contacts, and correspondingly storing a capability type of each contact and a feature code corresponding to the capability type, a terminal can automatically realize identification of the capability types of contacts in a contact database, for example, through network query, a functional module integrating capability type identification, etc., without a user's complex operation of setting a corresponding capability type for each contact, thereby further enhancing the user experience.

Preferably, after the found contacts are used as the target contacts, the above technical solution further comprises: displaying information of the target contacts at a predetermined position of a terminal, and displaying an identifier of the capability type possessed by the target contacts in an area associated with the predetermined position.

In this technical solution, through displaying information of the target contacts at a predetermined position, and displaying an identifier of the capability type possessed by the target contacts in an area associated with the predetermined position, a user can intuitively view the capability type possessed by the target contacts, thereby facilitating the user to select an appropriate communication way for communication with the target contacts. The capability type identifier includes: an icon, a name, etc.

Preferably, the above technical solution further comprises: when a user inputs the search string, displaying an auxiliary character string corresponding to the character according to the character having been input by the user, so as to facilitate the user to select input.

When a user inputs a search string, this technical solution displays an auxiliary character string corresponding to the input character according to the character having been input by the user, so that the user can select and directly input an appropriate character string in the displayed auxiliary character string, reduce his operation process, facilitate his input, and enhance the user experience in operation.

Preferably, the above technical solution further comprises: determining whether the target contacts have a plurality of capability types according to information of the found target contacts; and when determining that the target contacts have a plurality of capability types, selecting a communication way for communication between a plurality of contacts according to a capability type jointly supported by the plurality of contacts requiring communication and a current network state upon receipt of an instruction for communication with the target contacts.

In the technical solution, when determining that the target contacts have a plurality of capability types, through selecting a communication way for the plurality of contacts according to a capability type jointly supported by the plurality of contacts in communication and a current network state upon receipt of an instruction for communication with the target contacts, it is possible to automatically select a preferred communication way for communication for a user, thereby avoiding affecting the communication quality because the user selects an inappropriate communication way, and also avoiding affecting an experience effect because the user does not know how to select a communication way. Specifically, if a target contact supports a voice communication and a video communication, and if determining that the current network is in good condition, and a plurality of communication parties support video communication therebetween, then it is possible to automatically select the video communication way for communication. In addition, if the target contact only has one capability type, then it is possible to directly select a communication way corresponding to the capability type possessed by the target contact for communication.

According to another aspect of the present invention, the present invention further proposes a system for searching for special contacts, comprising: a receiving unit, for receiving a search string input by a user; a parsing unit, for parsing the search string to obtain a feature code corresponding to a capability type of target contacts and a keyword used for searching to obtain the target contacts; and a search unit, for, according to the feature code and the keyword, searching, in a contact database, for contacts having contact information matching the keyword and having the capability type corresponding to the feature code, and using the found contacts as the target contacts.

In the technical solution, through parsing a search string input by a user to obtain a feature code corresponding to a capability type of target contacts and a keyword used for searching to obtain the target contacts, the user can realize exact search for target contacts having a specified capability type through searching for target contacts in a contact database by inputting a search string comprising a feature code corresponding to a capability type of target contacts, and can also find information of all the target contacts having the specified capability type, thereby meeting a user demand of searching for special contacts (such as RCS contacts), avoiding the problem that it is impossible for a user to only search for special contacts because search can only be carried out by keywords in relevant technologies, improving the accuracy of contact search, and contributing to improvement of the operating experience of the user. If the keyword obtained through parsing the search string is empty, it indicates that it is necessary to search for all the contacts having the capability type corresponding to the parsed feature code; or if the feature code obtained through parsing the search string is empty, it indicates that contacts are searched for only based on the user-entered search string as the keyword.

Preferably, the operation of the search unit of searching, in a contact database, for contacts having contact information matching a keyword and having a capability type corresponding to a feature code in accordance with the feature code and the keyword, may be firstly searching according to the feature code and then searching according to the keyword, namely, searching, in a contact database, for contacts having the capability type corresponding to the feature code according to the feature code, and searching for information of the target contacts from the contacts having the capability type found through the keyword; and may also be firstly searching based on the keyword and then searching based on the feature code, or searching based on both the keyword and the feature code.

Preferably, the above technical solution further comprises: an identifying unit, for, before the operation of the search unit of searching, in a contact database, for contacts having contact information matching the keyword and having the capability type corresponding to the feature code, identifying capability types of all the contacts in the contact database; and a storage unit, for correspondingly storing a capability type of each contact among all the contacts, as well as the feature code corresponding to the capability type.

In this technical solution, through identifying the capability types of all the contacts, and correspondingly storing a capability type of each contact and a feature code corresponding to the capability type, a terminal can automatically realize identification of the capability types of contacts in a contact database, for example, through network query, a functional module integrating capability type identification, etc., without a user's complex operation of setting a corresponding capability type for each contact, thereby further enhancing the user experience.

Preferably, the above technical solution further comprises: a first display unit, for displaying information of the target contacts at a predetermined position of a terminal, and displaying an identifier of the capability type possessed by the target contacts in an area associated with the predetermined position.

In this technical solution, through displaying information of the target contacts at a predetermined position, and displaying an identifier of the capability type possessed by the target contacts in an area associated with the predetermined position, a user can intuitively view the capability type possessed by the target contacts, thereby facilitating the user to select an appropriate communication way for communication with the target contacts. The capability type identifier includes: an icon, a name, etc.

Preferably, the above technical solution further comprises: a second display unit, for, when a user inputs the search string, displaying an auxiliary character string corresponding to the character according to the character having been input by the user, so as to facilitate the user to select input.

When a user inputs a search string, this technical solution displays an auxiliary character string corresponding to the input character according to the character having been input by the user, so that the user can select and directly input an appropriate character string in the displayed auxiliary character string, reduce his operation process, facilitate his input, and enhance the user experience in operation.

Preferably, the above technical solution further comprises: a determining unit, for determining whether the target contacts have a plurality of capability types according to information of the target contacts found through the search unit; and a processing unit, for, when the determining unit determines that the target contacts have a plurality of capability types, selecting a communication way for communication between a plurality of contacts according to a capability type jointly supported by the plurality of contacts requiring communication and a current network state upon receipt of an instruction for communication with the target contacts.

In the technical solution, when determining that the target contacts have a plurality of capability types, through selecting a communication way for a plurality of contacts according to a capability type jointly supported by the plurality of contacts in communication and a current network state upon receipt of an instruction for communication with the target contacts, it is possible to automatically select a preferred communication way for communication for a user, thereby avoiding affecting the communication quality because the user selects an inappropriate communication way, and also avoiding affecting an experience effect because the user does not know how to select a communication way. Specifically, if a target contact supports a voice communication and a video communication, and if determining that the current network is in good condition, and a plurality of communication parties support video communication therebetween, then it is possible to automatically select the video communication way for communication. In addition, if the target contact only has one capability type, then it is possible to directly select a communication way corresponding to the capability type possessed by the target contact for communication.

According to another aspect of the present invention, there is also provided an electronic device that comprises a processor and a memory communicably connected with the processor for storing program codes executable by the processor, wherein, execution of the program codes by the processor causes the processor to receive a search string input by a user; parse the search string to obtain a feature code corresponding to a capability type of target contacts and a keyword used for searching to obtain the target contacts; and search according to the feature code and the keyword in a contact database for contacts having contact information matching the keyword and having the capability type corresponding to the feature code, and use the found contacts as the target contacts.

Preferably, before searching in the contact database for contacts having contact information matching the keyword and having the capability type corresponding to the feature code, the processor is caused to identify the capability types of all the contacts in the contact database; and correspondingly store a capability type of each contact among all the contacts, and a feature code corresponding to the capability type.

Preferably, after using the found contacts as the target contacts, the processor is caused to display information of the target contacts at a predetermined position of a terminal, and display an identifier of the capability type possessed by the target contacts in an area associated with the predetermined position.

Preferably, the processor is further caused to, when a user inputs the search string, display an auxiliary character string corresponding to the character according to the character having been input by the user, so as to facilitate the user to select input.

Preferably, the processor is further caused to determine whether the target contacts have a plurality of capability types according to information of the found target contacts; and, when it is determined that the target contacts have a plurality of capability types, select a communication way for communication between a plurality of contacts according to a capability type jointly supported by the plurality of contacts requiring communication and a current network state upon receipt of an instruction for communication with the target contacts.

By means of the above technical solution, exact search for target contacts having a specified capability type is realized, and information of all the target contacts having the specified capability type can be found, thereby meeting a user demand of searching for special contacts (such as RCS contacts), improving the accuracy of contact search, and contributing to improvement of the operating experience of the user. In addition, the above technical solution can intuitively present the capability type possessed by the found target contacts, and facilitates a user to select an appropriate communication way for communication with the target contacts.

### BRIEF DESCRIPTION OF THE DRAWINGS

FIG. 1 shows a schematic flow diagram of a method for searching for special contacts according to an embodiment of the present invention;

FIG. 2 shows a schematic block diagram of a system for searching for special contacts according to an embodiment of the present invention;

FIG. 3 shows a schematic flow diagram of a method for searching for RCS contacts according to an embodiment of the present invention;

FIG. 4 shows a schematic block diagram of a device for searching for RCS contacts according to an embodiment of the present invention; and

FIG. 5 shows a schematic diagram of an interface for displaying searching results according to an embodiment of the present invention;

FIG. 6 shows a block diagram of an electronic device according to an embodiment of the present invention.

### DESCRIPTION OF THE EMBODIMENTS

For a better understanding of the aforementioned objects, features and advantages of the present invention, the present invention is further described in detail below in conjunction with the drawings and embodiments. It is necessary to indicate that, in case of no conflict, the embodiments of the present application and the features of the embodiments can be mutually combined.

Many specific details are described in the following description in order to fully understand the present invention. However, the present invention can also be implemented in other ways different from those described herein. Therefore, the scope of protection of the present invention is not limited to the embodiments disclosed below.

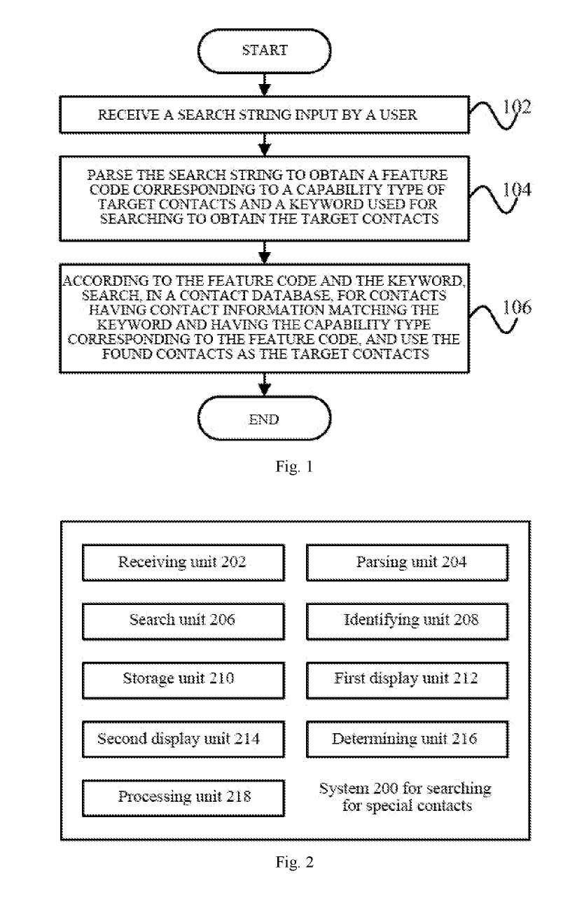

FIG. 1 shows a schematic flow diagram of a method for searching for special contacts according to an embodiment of the present invention.

As shown in FIG. 1, a method for searching for special contacts according to an embodiment of the present invention comprises: step 102: receiving a search string input by a user; step 104: parsing the search string to obtain a feature code corresponding to a capability type of target contacts and a keyword used for searching to obtain the target contacts; and step 106: according to the feature code and the keyword, searching, in a contact database, for contacts having contact information matching the keyword and having the capability type corresponding to the feature code, and using the found contacts as the target contacts.

In the technical solution, through parsing a search string input by a user to obtain a feature code corresponding to a capability type of target contacts and a keyword used for searching to obtain the target contacts, a user can realize exact search for the target contacts having a specified capability type through searching for the target contacts in a contact database by inputting a search string comprising the feature code corresponding to the capability type of the target contacts, and can also find information of all the target contacts having the specified capability type, thereby meeting a user demand of searching for special contacts (such as RCS contacts), avoiding the problem that it is impossible for a user to only search for special contacts because search can only be carried out by keywords in relevant technologies, improving the accuracy of contact search, and contributing to improvement of the operating experience of the user. If the keyword obtained through parsing the search string is empty, it indicates that it is necessary to search for all the contacts having the capability type corresponding to the parsed feature code; or if the feature code obtained through parsing the search string is empty, it indicates that contacts are searched for only based on the user-entered search string as the keyword.

Preferably, the above step of searching, in a contact database, for contacts having contact information matching a keyword and having a capability type corresponding to a feature code in accordance with the feature code and the keyword, may be firstly searching according to the feature code and then searching according to the keyword, namely, searching for contacts having the capability type corresponding to the feature code in a contact database according to the feature code, and searching for information of the target contacts from the contacts having the capability type found through the keyword; and may also be firstly searching based on the keyword and then searching based on the feature code, or searching based on both the keyword and the feature code.

Preferably, before the step of searching, in a contact database, for contacts having contact information matching the keyword and having the capability type corresponding to the feature code, the above technical solution further comprises: identifying capability types of all the contacts in the contact database; and correspondingly storing a capability type of each contact among all the contacts, as well as the feature code corresponding to the capability type.

In this technical solution, through identifying the capability types of all the contacts, and correspondingly storing a capability type of each contact and a feature code corresponding to the capability type, a terminal can automatically realize identification of the capability types of contacts in a contact database, for example, through network query, a functional module integrating capability type identification, etc., without a user's complex operation of setting a corresponding capability type for each contact, thereby further enhancing the user experience.

In the above technical solution, preferably, after the found contacts are used as the target contacts, the technical solution further comprises: displaying information of the target contacts at a predetermined position of a terminal, and displaying an identifier of the capability type possessed by the target contacts in an area associated with the predetermined position.

In this technical solution, through displaying information of the target contacts at a predetermined position, and displaying an identifier of the capability type possessed by the target contacts in an area associated with the predetermined position, a user can intuitively view the capability type possessed by the target contacts, thereby facilitating the user to select an appropriate communication way for communication with the target contacts. The capability type identifier includes: an icon, a name, etc.

Preferably, the above technical solution further comprises: when a user inputs the search string, displaying an auxiliary character string corresponding to the character according to the character having been input by the user, so as to facilitate the user to select input.

When a user inputs a search string, this technical solution displays an auxiliary character string corresponding to the input character according to the character having been input by the user, so that the user can select and directly input an appropriate character string in the displayed auxiliary character string, reduce his operation process, facilitate his input, and enhance the user experience in operation.

Preferably, the above technical solution further comprises: determining whether the target contacts have a plurality of capability types according to information of the found target contacts; and when determining that the target contacts have a plurality of capability types, selecting a communication way for communication between a plurality of contacts according to a capability type jointly supported by the plurality of contacts requiring communication and a current network state upon receipt of an instruction for communication with the target contacts.

In the technical solution, when determining that the target contacts have a plurality of capability types, through selecting a communication way for a plurality of contacts according to a capability type jointly supported by the plurality of contacts in communication and a current network state upon receipt of an instruction for communication with the target contacts, it is possible to automatically select a preferred communication way for communication for a user, thereby avoiding affecting the communication quality because the user selects an inappropriate communication way, and also avoiding affecting an experience effect because the user does not know how to select a communication way. Specifically, if a target contact supports a voice communication and a video communication, and if determining that the current network is in good condition, and a plurality of communication parties support video communication therebetween, then it is possible to automatically select the video communication way for communication. In addition, if the target contact only has one capability type, then it is possible to directly select a communication way corresponding to the capability type possessed by the target contact for communication.

FIG. 2 shows a schematic block diagram of a system for searching special contacts according to an embodiment of the present invention.

As shown in FIG. 2, a system 200 for searching for special contacts according to an embodiment of the present invention comprises: a receiving unit 202, for receiving a search string input by a user; a parsing unit 204, for parsing the search string to obtain a feature code corresponding to a capability type of target contacts and a keyword used for searching to obtain the target contacts; and a search unit 206, for, according to the feature code and the keyword, searching, in a contact database, for contacts having contact information matching the keyword and having the capability type corresponding to the feature code, and using the found contacts as the target contacts.

In the technical solution, through parsing a search string input by a user to obtain a feature code corresponding to a capability type of target contacts and a keyword used for searching to obtain the target contacts, a user can realize exact search for target contacts having a specified capability type through searching for target contacts in a contact database by inputting a search string comprising a feature code corresponding to a capability type of the target contacts, and can also find information of all the target contacts having the specified capability type, thereby meeting a user demand of searching for special contacts (such as RCS contacts), avoiding the problem that it is impossible for a user to only search for special contacts because search can only be carried out by keywords in relevant technologies, improving the accuracy of contact search, and contributing to improvement of the operating experience of the user. If the keyword obtained through parsing the search string is empty, it indicates that it is necessary to search for all the contacts having the capability type corresponding to the parsed feature code; or if the feature code obtained through parsing the search string is empty, it indicates that contacts are searched for only based on the user-entered search string as the keyword.

Preferably, the operation of the search unit 206 of searching, in a contact database, for contacts having contact information matching a keyword and having a capability type corresponding to a feature code in accordance with the feature code and the keyword, may be firstly searching according to the feature code and then searching according to the keyword, namely, searching, in a contact database, for contacts having the capability type corresponding to the feature code according to the feature code, and searching for information of the target contacts from the contacts having the capability type found through the keyword; and may also be firstly searching based on the keyword and then searching based on the feature code, or searching based on both the keyword and the feature code.

Preferably, the above technical solution further comprises: an identifying unit 208, for, before the operation of the search unit 206 of searching, in a contact database, for contacts having contact information matching the keyword and having the capability type corresponding to the feature code, identifying capability types of all the contacts in the contact database; and a storage unit 210, for correspondingly storing a capability type of each contact among all the contacts, as well as the feature code corresponding to the capability type.

In this technical solution, through identifying the capability types of all the contacts, and correspondingly storing a capability type of each contact and a feature code corresponding to the capability type, a terminal can automatically realize identification of the capability types of contacts in a contact database, for example, through network query, a functional module integrating capability type identification, etc., without a user's complex operation of setting a corresponding capability type for each contact, thereby further enhancing the user experience.

In the above technical solution, preferably, the technical solution further comprises: a first display unit 212, for displaying information of the target contacts at a predetermined position of a terminal, and displaying an identifier of the capability type possessed by the target contacts in an area associated with the predetermined position.

In this technical solution, through displaying information of the target contacts at a predetermined position, and displaying an identifier of the capability type possessed by the target contacts in an area associated with the predetermined position, a user can intuitively view the capability type possessed by the target contacts, thereby facilitating the user to select an appropriate communication way for communication with the target contacts. The capability type identifier includes: an icon, a name, etc.

Preferably, the above technical solution further comprises: a second display unit 214, for, when a user inputs the search string, displaying an auxiliary character string corresponding to the character according to the character having been input by the user, so as to facilitate the user to select input.

When a user inputs a search string, this technical solution displays an auxiliary character string corresponding to the input character according to the character having been input by the user, so that the user can select and directly input an appropriate character string in the displayed auxiliary character string, reduce his operation process, facilitate his input, and enhance the user experience in operation.

Preferably, the above technical solution further comprises: a determining unit 216, for determining whether the target contacts have a plurality of capability types according to information of the target contacts found through the search unit 206; and a processing unit 218, for, when the determining unit 216 determines that the target contacts have a plurality of capability types, selecting a communication way for communication between a plurality of contacts according to a capability type jointly supported by the plurality of contacts requiring communication and a current network state upon receipt of an instruction for communication with the target contacts.

In the technical solution, when determining that the target contacts have a plurality of capability types, through selecting a communication way for a plurality of contacts according to a capability type jointly supported by the plurality of contacts in communication and a current network state upon receipt of an instruction for communication with the target contacts, it is possible to automatically select a preferred communication way for communication for a user, thereby avoiding affecting the communication quality because the user selects an inappropriate communication way, and also avoiding affecting an experience effect because the user does not know how to select a communication way. Specifically, if a target contact supports a voice communication and a video communication, and if determining that the current network is in good condition, and a plurality of communication parties support video communication therebetween, then it is possible to automatically select the video communication way for communication. In addition, if the target contact only has one capability type, then it is possible to directly select a communication way corresponding to the capability type possessed by the target contacts for communication.

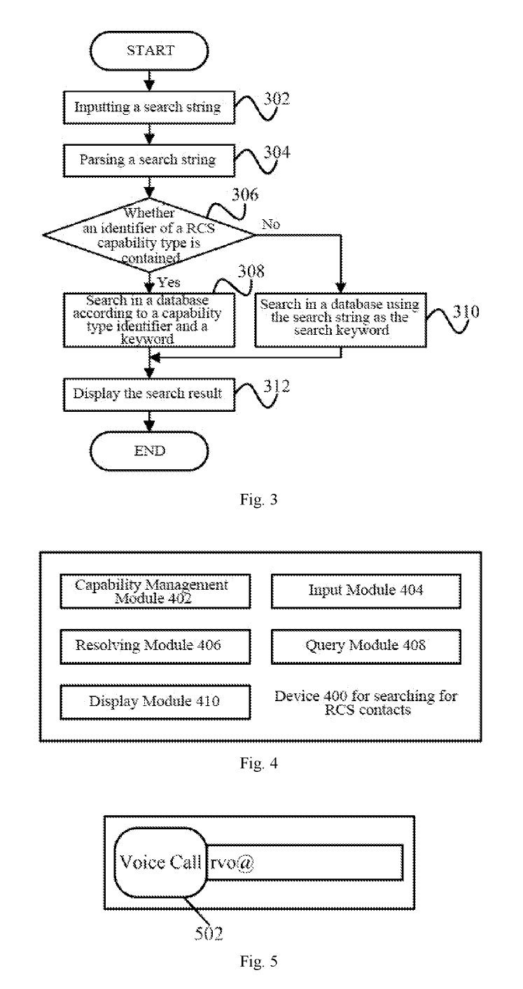

The technical solution of the present invention is described in detail below with RCS contacts as the special contacts in conjunction with FIG. 3 to FIG. 5.

The present invention mainly judges whether a search string input by a user meets set requirements, namely “feature code+search keyword”, extracts the corresponding feature code and search keyword from the search string if the search string input by the user meets the requirements, needs to match the feature code with a predetermined RCS capability type identifier between the feature code and the search keyword through a specified special character segmentation (e.g., @symbol), and then searches in a contact database using a matching capability type identifier and a search keyword, so as to obtain target contacts satisfying the search conditions. The specific processing may be as shown in FIG. 3.

FIG. 3 shows a schematic flow diagram of a method for searching for RCS contacts according to an embodiment of the present invention.

As shown in FIG. 3, a method for searching for RCS contacts according to an embodiment of the present invention comprises the following steps:
Step 302: Inputting a search string;
Step 304: Parsing a search string;
Step 306: Determining whether the content of the parsed search string contains a RCS capability type identifier, and performing step 308 if the content of the parsed search string contains a RCS capability type identifier; or otherwise, performing step 310;
Step 308: Searching in a database according to the RCS capability type identifier and the keyword when determining that the content of the parsed search string contains the RCS capability type identifier;
Step 310: Searching in a database using the search string as the search keyword when determining that the content of the parsed search string does not contain the RCS capability type identifier; and
Step 312: Displaying the search results.

FIG. 4 shows a schematic block diagram of a device for searching for RCS contacts according to an embodiment of the present invention.

As shown in FIG. 4, a device 400 for searching for RCS contacts according to an embodiment of the present invention comprises the following modules:
a capability management module 402, an input module 404, a resolving module 406, a query module 408 and a display module 410.

The capability management module 402 is mainly used for establishing a mapping between RCS contact ID and capability ID, so as to provide a guarantee for quickly searching contacts with a corresponding capability. Each capability type of RCS contacts corresponds to a search identifier, and a corresponding capability type can be found based on a search identifier during a search. A mapping relation between capability types of RCS contacts and search identifiers may be as shown in Table 1:

TABLE 1

| Capability types of RCS contacts | Search identifier |
|---|---|
| Voice call | rvo |
| Video call | rvi |
| File transfer | rf |
| Chat | rc |
| SMS | rs |
| MMS | rm |

As shown in Table 1, each capability type of RCS contacts corresponds to a search identifier. A search identifier helps to determine capability types of RCS contacts. For example, if a user inputs “rvo”, it is possible to determine that it is necessary to search RCS contacts having a “Voice call” capability.

The input module 404 is mainly used for receiving a user input, and can automatically pop up an input prompt as needed. For example, if a user inputs “r”, then rc@, rvo@, rvi@, rf@ and other prompts can be popped up to facilitate the user to select input.

The resolving module 406 is mainly used for resolving a string input by a user. For example, if a user inputs “rvo@jim”, then the resolved feature code is “rvo”, and the keyword is “jim”, which is interpreted as that the user wants to search for a RCS contact having a voice call capability named jim. It is necessary to note that, if a user inputs “rvo@”, then it can be understood as that the feature code is “rvo”, and the keyword is empty. In that way, all the RCS contacts having a voice call capability will be found. In addition, if the name of a contact existing in a contact database is rvo@, then it is also possible to find and display the contact in the search result, for example, displaying the contact in the end of the search result.

The query module 408 is mainly used for acquiring output of the resolving module 406, searching in a contact database through a feature code of a capability type and a keyword, and returning to the query result.

The display module 410 is mainly used for displaying the found result whilst displaying an operation icon corresponding to the current capability type in front of a search box. For example, after a user inputs “rvo@”, then a Voice Call Icon (e.g. icon 5025 as shown in FIG. 5) will be automatically popped up in front of a display box of a search structure, and a voice call for all the found contacts will be originated if the user clicks on the icon; at the same time, a display list can also provide a function for the user to select in view of the search result.

In addition, if a character string input by a user does not meet matching of a feature code of any capability type, then search is carried out with the character string input by the user as a keyword in accordance with the normal search process.

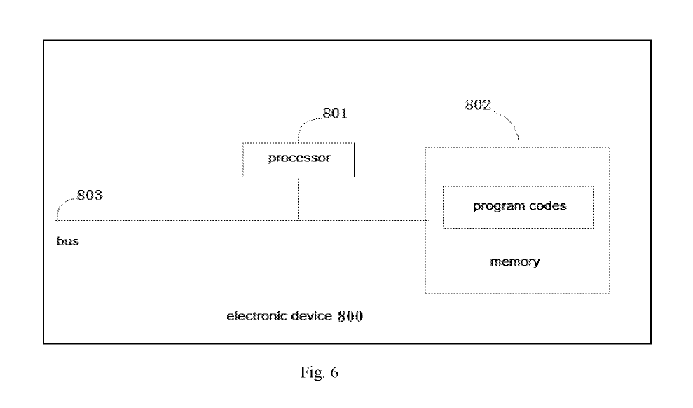

FIG. 6 shows a block diagram of an electronic device according to an embodiment of the present invention. As shown in FIG. 6, the electronic device 800 for service processing comprises a processor 801 and a memory 802 communicably connected with the processor 801 for program codes executable by the processor 801, wherein execution of the program codes by the processor 801 causes the processor 801 to receive a search string input by a user; parse the search string to obtain a feature code corresponding to a capability type of target contacts and a keyword used for searching to obtain the target contacts; and search according to the feature code and the keyword in a contact database for contacts having contact information matching the keyword and having the capability type corresponding to the feature code, and use the found contacts as the target contacts. The processor 801 and the memory 802 is communicably connected by a bus 803.

Preferably, before searching in the contact database for contacts having contact information matching the keyword and having the capability type corresponding to the feature code, the processor 801 is caused to identify the capability types of all the contacts in the contact database; and correspondingly store a capability type of each contact among all the contacts, and a feature code corresponding to the capability type.

Preferably, after using the found contacts as the target contacts, the processor 801 is caused to display information of the target contacts at a predetermined position of a terminal, and display an identifier of the capability type possessed by the target contacts in an area associated with the predetermined position.

Preferably, the processor 801 is further caused to, when a user inputs the search string, display an auxiliary character string corresponding to the character according to the character having been input by the user, so as to facilitate the user to select input.

Preferably, the processor 801 is further caused to determine whether the target contacts have a plurality of capability types according to information of the found target contacts; and, when it is determined that the target contacts have a plurality of capability types, select a communication way for communication between a plurality of contacts according to a capability type jointly supported by the plurality of contacts requiring communication and a current network state upon receipt of an instruction for communication with the target contacts.

The technical solution of the present invention is described in detail above in conjunction with the appended drawings. The present invention proposes a novel solution for searching for special contacts, which realizes exact search for target contacts having a specified capability type, and can also find information of all the target contacts having the specified capability type, thereby meeting a user demand of searching for special contacts (such as RCS contacts), improving the accuracy of contact search, and contributing to improvement of the operating experience of the user. In addition, the above solution can intuitively present the capability type possessed by the found target contacts, and facilitates a user to select an appropriate communication way for communication with the target contacts.

The foregoing is only preferred embodiments of the present invention, which are not intended to limit the present invention. For those skilled in the art, the present invention may have various alterations and variations. Any modifications, equivalent substitutions, improvement and the like made within the spirit and principles of the present invention should be included within the scope of protection of the present invention.

1. A method for searching for special contacts, comprising:
receiving a search string input by a user;
parsing the search string to obtain a feature code corresponding to a capability type of target contacts and a keyword used for searching to obtain the target contacts; and
according to the feature code and the keyword, searching, in a contact database, for contacts having contact information matching the keyword and having the capability type corresponding to the feature code, and using the found contacts as the target contacts.

2. The method for searching for special contacts according to claim 1, further comprising the following steps before the step of searching, in a contact database, for contacts having contact information matching the keyword and having the capability type corresponding to the feature code:
identifying the capability types of all the contacts in the contact database; and
correspondingly storing a capability type of each contact among all the contacts, and a feature code corresponding to the capability type.

3. The method for searching for special contacts according to claim 1, further comprising the following steps after using the found contacts as the target contacts:
displaying information of the target contacts at a predetermined position of a terminal, and displaying an identifier of the capability type possessed by the target contacts in an area associated with the predetermined position.

4. The method for searching for special contacts according to claim 1, further comprising the following step:
when a user inputs the search string, displaying an auxiliary character string corresponding to the character according to the character having been input by the user, so as to facilitate the user to select input.

5. The method for searching for special contacts according to claim 1, further comprising the following steps:
determining whether the target contacts have a plurality of capability types according to information of the found target contacts; and
when determining that the target contacts have a plurality of capability types, selecting a communication way for communication between a plurality of contacts according to a capability type jointly supported by the plurality of contacts requiring communication and a current network state upon receipt of an instruction for communication with the target contacts.

6. An electronic device, comprising a processor and a memory communicably connected with the processor for storing program codes executable by the processor, wherein, execution of the program codes by the processor causes the processor to
receive a search string input by a user;
parse the search string to obtain a feature code corresponding to a capability type of target contacts and a keyword used for searching to obtain the target contacts; and
search according to the feature code and the keyword in a contact database for contacts having contact information matching the keyword and having the capability type corresponding to the feature code, and use the found contacts as the target contacts.

7. The electronic device according to claim 6, before searching in the contact database for contacts having contact information matching the keyword and having the capability type corresponding to the feature code, the processor is caused to
identify the capability types of all the contacts in the contact database; and
correspondingly store a capability type of each contact among all the contacts, and a feature code corresponding to the capability type.

8. The electronic device according to claim 6, after using the found contacts as the target contacts, the processor is caused to
display information of the target contacts at a predetermined position of a terminal, and display an identifier of the capability type possessed by the target contacts in an area associated with the predetermined position.

9. The electronic device according to claim 6, the processor is further caused to
when a user inputs the search string, display an auxiliary character string corresponding to the character according to the character having been input by the user, so as to facilitate the user to select input.

10. The electronic device according to claim 6, the processor is further caused to
determine whether the target contacts have a plurality of capability types according to information of the found target contacts; and
when it is determined that the target contacts have a plurality of capability types, select a communication way for communication between a plurality of contacts according to a capability type jointly supported by the plurality of contacts requiring communication and a current network state upon receipt of an instruction for communication with the target contacts.
